(19) United States
(12) Patent Application Publication
(10) Pub. No.: US 2025/0020239 A1
(43) Pub. Date: Jan. 16, 2025

(54) Subsea Dual Set Multi-Piston Mechanism

(71) Applicant: Oceaneering International, Inc., Houston, TX (US)

(72) Inventors: Sam MCKINLAY, Houston, TX (US); Chen CHENG, Houston, TX (US)

(73) Assignee: Oceaneering International, Inc., Houston, TX (US)

(21) Appl. No.: 18/770,978

(22) Filed: Jul. 12, 2024

Related U.S. Application Data
(60) Provisional application No. 63/526,604, filed on Jul. 13, 2023.

(51) Int. Cl. F16L 1/26; F16L 23/036; F16L 23/18

(52) U.S. Cl. CPC F16L 1/26; F16L 23/036; F16L 23/18

(57) ABSTRACT

A subsea dual set multi-piston smart flange (1) comprises a predetermined set of tensioning sleeves (52) which accept a corresponding predetermined set of tensioning rods (50) therethrough and a corresponding predetermined set of tensioners (53) corresponding in number to the number of predetermined set of tensioning rods (50), where each tensioner (53) of the predetermined set of tensioners (53) makes its tensioning sleeve (52) act like a piston to adjustably force pressure edges (56) of each tensioner (53) against a seal actuator (14), thereby applying pressure to and compressing a compressible seal (30) disposed within a first tubular (10).

### RELATION TO OTHER APPLICATIONS

This application claims priority through U.S. Provisional Application 63/526,604 filed on Jul. 17, 2023, incorporated herein by reference.

### BACKGROUND

The disclosed invention relates to a subsea dual set multi-piston mechanism and method of using setting of the subsea dual set multi-piston mechanism through a multiple piston mechanism of the subsea dual set multi-piston mechanism.

Current subsea pipeline repair connector technology all has the use of setting seals using different mechanisms while achieving the same output. This can involve a single set mechanism with the shared setting of a grip (holding on the pipe structurally) to an individual setting mechanism.

Installation efficiency is one of the main factors when installing pipeline repair connectors. Typically depending on which type of mechanism is used, time is one of the main factors. When using a single set mechanism to set the seals the input of setting the seals involve using a torque method. A series of fasteners interface with a flange which then interfaces with the seals. This involves individually setting one fastener in a specific pattern. Even though this is a common method minor risk of wedging on one side of the flange can occur and time can be added.

### FIGURES

Various figures are included herein which illustrate aspects of embodiments of the disclosed inventions.

FIG. 1 is a view in partial perspective of an exemplary subsea dual set multi-piston smart flange in an assembled condition;

FIG. 2 is a cutaway view in partial perspective of an exemplary subsea dual set multi-piston smart flange illustrating a seal actuator;

FIG. 3 is a cutaway view in partial perspective of an exemplary subsea dual set multi-piston smart flange in an assembled condition;

FIG. 4 is a view in partial perspective of an exemplary subsea dual set multi-piston smart flange from an end perspective;

FIGS. 5-6 are views in partial perspective of an exemplary subsea dual set multi-piston smart flange in an assembled condition;

FIG. 7 is a view in partial perspective of two exemplary subsea dual set multi-piston smart flanges at either end of a tubular; and

FIG. 8 is a view in partial perspective of a tensioner.

### DESCRIPTION OF EXEMPLARY EMBODIMENTS

Subsea dual set multi-piston smart flange 1 provides an independent setting of seals, thereby providing substantially simultaneous tensioning of fasteners at the same time to provide efficient load.

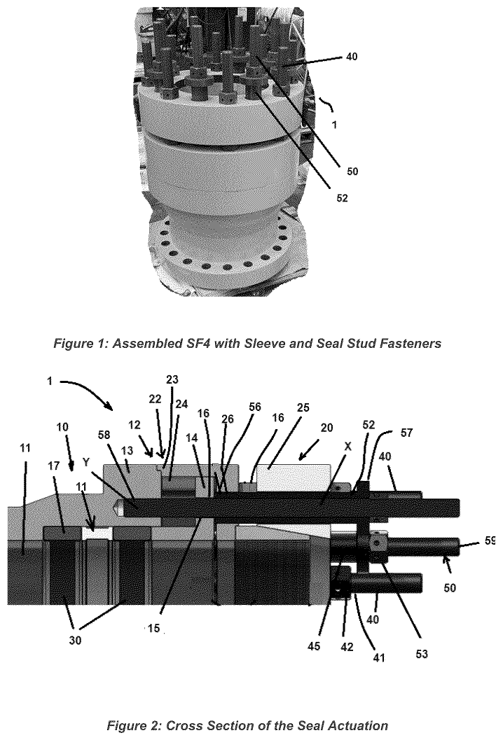

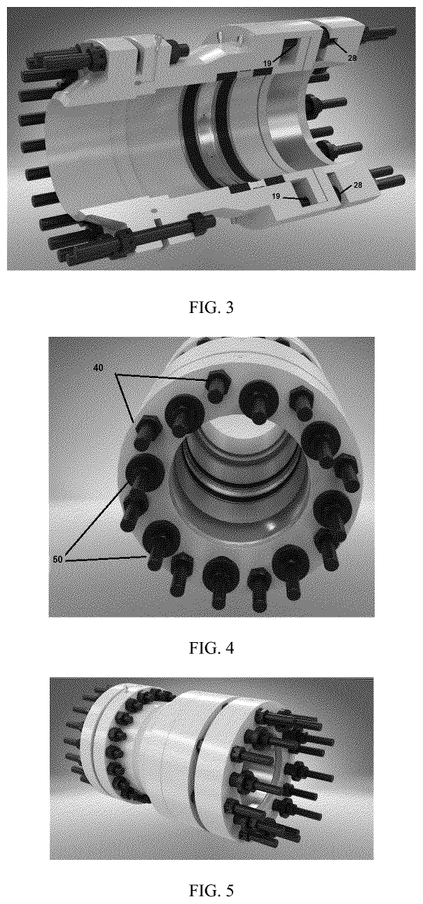

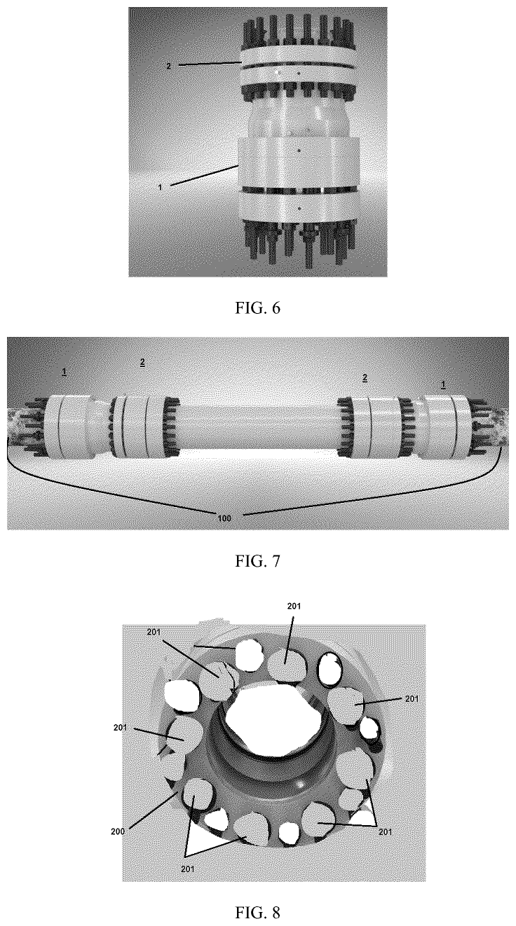

Referring to FIG. 1, in an embodiment subsea dual set multi-piston smart flange 1 comprises a predetermined set of tensioning rods 50; a predetermined set of tensioning sleeves 52 corresponding in number to the number of the predetermined set of tensioning rods 50; a predetermined set of tensioners 53 corresponding in number to the number of predetermined set of tensioning rods 50; first tubular 10; second tubular 20; and one or more compressible seals 30.

Typically, each tensioning rod 50 comprises securing edge 58, which typically comprises a threaded portion configured to be accepted and mated into a corresponding thread receiver in first tubular 10, and tensioning edge 59 located distally from securing edge 58. In some embodiments one or more, typically each, tensioning edge 59 comprises a threaded portion and each tensioner 53 of the predetermined set of tensioners 53 comprises nut 53 complimentarily threaded to selectively engage a corresponding threaded portion of tensioning edge 59.

In embodiments, each tensioning sleeve 52 of the predetermined set of tensioning sleeves 52 is configured to accept one tensioning rod 50 of the predetermined set of tensioning rods 50 therethrough, and comprises pressure edge 56 and collar 57 disposed distally from pressure edge 56 proximate tensioning edge 59, thus defining a predetermined set of pressure edges 56 and collars 57 agreeing in number the number of the predetermined set of tensioning rods 50. A predetermined set of tensioners 53 corresponding in number to the number of predetermined set of tensioning rods 50 is typically provided where each tensioner 53 of the predetermined set of tensioners 53 is configured to fit about a corresponding tensioning rod 50 of the predetermined set of tensioning rods 50 proximate tensioning edge 59.

In embodiments, first tubular 10 comprises an inner diameter defining a first inner channel 11, first end 12, first flanged face 13 disposed at first end 12, a first plurality of tensioning sleeve ports 16 disposed circumferentially at and through first end 12 where each tensioning sleeve port 16 is configured to accept one tensioning sleeve 52 of the predetermined set of tensioning sleeves 52 therethrough, seal receiver 17 disposed within first inner channel 11 proximate first end 12, and seal actuator 14 slidingly disposed at least partially within seal receiver 17. Typically, seal actuator 14 comprises a set of tension rod ports 15 corresponding in number to the number of first plurality of tensioning sleeve ports 16, each tension rod port 15 of the set of tension rod ports 15 being sized to be smaller in diameter than an outer diameter of each tensioning sleeve 52 of the predetermined set of tensioning sleeves 52 and sized to accept one tensioning rod 50 of the predetermined set of tensioning rods 50 therethrough. Each tensioning rod 50 of the predetermined set of tensioning rods 50 is typically configured to secure into first flanged face 12 to selectively apply an adjustable load pressure to seal actuator 14.

One or more compressible seals 30 is disposed within seal receiver 17 and seal actuator 14 slidingly engageable against compressible seal 30. Compressible seals 30 may comprise elastomer seals, graphite seals, or the like.

Second tubular 20 generally comprises substantially the same inner diameter as first tubular 10 where the inner diameter of second tubular 20 defines second inner channel 21. Second tubular 20 also comprises second end 22 and second flanged face 23 disposed at second end 22 and configured to abut first flanged face 12. Second flanged face 23 also defines actuator channel 23 between an outer portion of second flanged face 23 and an interior of second tubular 20, and seal actuator 14 is further slidingly disposed within actuator channel 23 proximate first end 12 such that travel of seal actuator 14 towards first tubular 10 is impeded by first flanged face 12. Second plurality of tensioning sleeve ports 26 is disposed circumferentially at and through second end 22 and corresponds in number to the number of the first plurality of tensioning sleeve ports 16, each tensioning sleeve port 26 of the second plurality of tensioning sleeve ports 26 configured to configured to align with a tension rod port (15) of the set of tension rod ports (15) and to accept one tensioning sleeve 52 of the predetermined set of tensioning sleeves 52 therethrough.

In embodiments, limiter 25 is present and disposed intermediate the predetermined set of collars 57 and second flanged face 23 and configured to act as a restraint for travel of the predetermined set of tensioning sleeves 52 towards first tubular 10.

In certain embodiments, subsea dual set multi-piston smart flange 1 further comprises a predetermined set of securing rods 40. In these embodiments, first tubular 10 further comprises a first plurality of securing rod ports 18 disposed circumferentially at and through first end 12 where each securing rod port 18 of the first plurality of securing rod ports 18 is configured to accept one securing rod 40 of the predetermined set of securing rods 40 therethrough. Further, in these embodiments seal actuator 14 further comprises a similar set of actuator securing rod ports 19 corresponding in number to the number of the first plurality of securing rod ports 18, where each actuator securing rod port 19 of the set of actuator securing rod ports 19 is also sized to accept one securing rod 40 of the predetermined set of securing rods 40 therethrough. In these embodiments, second tubular 20 further comprises a second plurality of securing rod ports 28 disposed circumferentially at and through second end 22, where each securing rod port 28 of the second plurality of securing rod ports 28 is configured to configured to align with a corresponding securing rod port 19 of the set of actuator securing rod ports 19 and accept a securing rod 40 of the predetermined set of securing rods 40 therethrough.

In addition, each securing rod 40 of the predetermined set of securing rods 40 is typically configured to secure into first tubular 1, e.g., proximate first flanged face 12, such as by having each securing rod 40 of the predetermined set of securing rods 40 comprise threaded end 41 configured to be accepted and mated into a corresponding thread receiver in the first tubular 10. One or more, typically each, securing rods 42 typically also comprises securing rod fastener 42 disposed distally from the end of securing rod received into first tubular 1 where securing rod fastener 42 may be a nut, a securing pin configured to be accepted through a securing pin channel in securing rod, or the like, or a combination thereof.

Typically, the first plurality of tensioning sleeve ports 16 and the second plurality of tensioning sleeve ports 26 are alternatively disposed equidistantly circumferentially, i.e., tensioning sleeve port 16 is followed circumferentially by tensioning sleeve port 26, followed by tensioning sleeve port 16, and so on.

In the operation of exemplary embodiments, tensioning of all fasteners 42,52 or a subset, e.g., tensioners 53, may occur substantially simultaneously and be set independently to provide efficient load distribution with minimum time for installation and contingency if required using subsea dual set multi-piston smart flange described above.

Typically, subsea dual set multi-piston smart flange 1 is interfaced at an end of tubular 1000 and each tensioner 53 of the predetermined set of tensioners 53 adjusted to apply pressure to each collar 57, forcing each pressure edge 56 against seal actuator 14 and, thereby, applying pressure to compressible seal 30. The adjustment may occur singly or in combination, e.g., all tensioners 53 substantially simultaneously.

Seal actuator 14 is allowed to travel towards tubular 100 but its travel is typically impeded by travel of seal actuator 14 towards first flanged face 12, e.g., in a direction from X to Y. In this manner, tensioning rods 50 disposed within their tensioning sleeves 52 act as pistons to apply pressure to compressible seal 30 via seal actuator 14 with load applied in a direction from X to Y.

Tensioner 200 (FIG. 8) may be present and configured to engage each tensioner 53 of the predetermined set of tensioners 53 more or less simultaneously by using tensioner 200 to simultaneously adjust each tensioner 53 of the predetermined set of tensioners 53 to a predetermined tension to apply a predetermined pressure to the compressible seal 30. In embodiments, tensioner 200 comprises a set of tension applicators 201 (FIG. 8) which correspond in number to the number of tensioner 53 of the predetermined set of tensioners 53, each tension applicator 201 sized to engage each tensioner 53 of the predetermined set of tensioners 53. Tension applicators 201 may comprise one or more torque wrenches or the like. However, tension may also be applied to each tensioner 53 of the predetermined set of tensioners 53 independently.

Further, tension applicators 201 may be operable subsea such as by a subsea apparatus, including a remotely operated vehicle or an autonomous under vehicle or the like or a combination thereof, by a human diver, or the like, or a combination thereof.

Where subsea dual set multi-piston smart flange 1 further comprises limiter 25 as described above, limiter 25 may be used to restrain the travel of the predetermined set of tensioning rods 50 towards first tubular 10 by impeding travel of tensioning sleeves 52 towards first tubular 10.

In embodiments where one or more securing rods 40 of the predetermined set of securing rods 40 comprises a threaded end configured to be accepted and mated into a corresponding thread receiver in first tubular 10, the threaded end of each securing rod 40 of the predetermined set of securing rods 40 may be advanced into a corresponding thread receiver in first tubular 10 and secured into its corresponding thread receiver in the first tubular 10 such as by tightening securing rod 40 to a predetermined torque.

Similarly, where each securing edge 58 comprises a threaded portion at one or either end of each tensioning rod 50 but at least at securing edge 58, at least one such threaded portion such as securing edge 58 may be configured to be accepted and advanced into a corresponding thread receiver in first tubular 10 and secured into its corresponding thread receiver in the first tubular 10 such as by tightening tension rod 50 to a predetermined torque.

In embodiments, adjusting each tensioner 53 of the predetermined set of tensioners 53 to force each pressure edge 56 against seal actuator 14 applies pressure thereby to compressible seal 30 and compresses compressible seal 30 by applying pressure to that tensioner's collar 57, thereby making that tensioning sleeve 52 act like a piston. If all tensioners 53 are substantially simultaneously adjusted, the effect is that each tensioning sleeve 52 substantially simultaneously acts like a multi-piston actuator.

In embodiments, subsea dual set multi-piston smart flange 1 operation acts as tensioners that can be daisy chained to actuate compressible seals 30 using all tensioning sleeves 52 without requiring torquing where such torquing can involve actuating each seal fastener one at a time, following a specific pattern on a bolt circle during which wedging can occur with the seal actuator outer diameter (OD) and the housing interface if one fastener is torqued more than others.

The foregoing disclosure and description of the inventions are illustrative and explanatory. Various changes in the size, shape, and materials, as well as in the details of the illustrative construction and/or an illustrative method may be made without departing from the spirit of the invention.

What is claimed is:

1. A subsea dual set multi-piston smart flange, comprising:
a) a predetermined set of tensioning rods, each tensioning rod comprising a securing edge and a tensioning edge;
b) a predetermined set of tensioning sleeves corresponding in number to the predetermined set of tensioning rods, each tensioning sleeve of the predetermined set of tensioning sleeves configured to accept a tensioning rod of the predetermined set of tensioning rods therethrough, each tensioning sleeve comprising a pressure edge and a collar;
c) a predetermined set of tensioners corresponding in number to the number of the predetermined set of tensioning rods, each tensioner of the predetermined set of tensioners configured to fit about a corresponding tensioning rod of the predetermined set of tensioning rods proximate the tensioning edge and secure that tensioning rod against the collar;
d) a first tubular, comprising:
i) an inner diameter defining a first inner channel;
ii) a first end;
iii) a first flanged face disposed at the first end;
iv) a first plurality of tensioning sleeve ports disposed circumferentially at and through the first end, each tensioning sleeve port configured to accept a tensioning sleeve of the predetermined set of tensioning sleeves therethrough;
v) a seal receiver disposed within the first inner channel proximate the first end; and
vi) a seal actuator slidingly disposed at least partially within the seal receiver, the seal actuator comprising a predetermined set of tension rod ports corresponding in number to the first plurality of tensioning sleeve ports, each tension rod port of the set of tension rod ports sized to be smaller in diameter than an outer diameter of each tensioning sleeve of the predetermined set of tensioning sleeves and sized to accept a tensioning rod of the predetermined set of tensioning rods therethrough, each tensioning rod of the predetermined set of tensioning rods configured to secure into the first flanged face, each tensioning sleeve of the predetermined set of tensioning sleeves configured to selectively apply an adjustable load pressure to the seal actuator;
e) a compressible seal disposed within the seal receiver, the seal actuator slidingly engageable against the compressible seal;
f) a second tubular, comprising:
i) an inner diameter substantially the same inner diameter as the first tubular, the second tubular inner diameter defining a second inner channel;
ii) a second end;
iii) a second flanged face disposed at the second end and configured to abut the first flanged face, the second flanged face defining an actuator channel between an outer portion of the second flanged face and an interior of the second tubular, the seal actuator further slidingly disposed within the actuator channel proximate the first end, travel of the seal actuator towards the first tubular impeded by the first flanged face; and
iv) a second plurality of tensioning sleeve ports disposed circumferentially at and through the second end and corresponding in number to the number of the first plurality of tensioning sleeve ports, each tensioning sleeve port of the second plurality of tensioning sleeve ports comprising an inner diameter larger than an outer diameter of the collars, each tensioning sleeve port of the second plurality of tensioning sleeve ports configured to align with a tension rod port of the set of tension rod ports and accept a tensioning sleeve of the predetermined set of tensioning sleeves therethrough.

2. The subsea dual set multi-piston smart flange of claim 1, further comprising a limiter disposed intermediate the collars and the second flanged face and configured to act as a restraint for travel of the predetermined set of tensioning sleeves towards the first tubular.

3. The subsea dual set multi-piston smart flange of claim 1, wherein:
a) each tensioning edge further comprises a threaded portion; and
b) each tensioner of the predetermined set of tensioners comprises a nut threaded for a corresponding threaded portion of each tensioning edge.

4. The subsea dual set multi-piston smart flange of claim 1, further comprising a predetermined set of securing rods, wherein:
a) the first tubular further comprises a first plurality of securing rod ports disposed circumferentially at and through the first end, each securing rod port of the first plurality of securing rod ports configured to accept a securing rod of the predetermined set of securing rods therethrough;
b) the seal actuator further comprises a set of actuator securing rod ports corresponding in number to the first plurality of securing rod ports, each actuator securing rod port of the set of actuator securing rod ports sized to accept a securing rod of the predetermined set of securing rods therethrough, each securing rod of the predetermined set of securing rods configured to secure into the first tubular; and
c) the second tubular further comprises a second plurality of securing rod ports disposed circumferentially at and through the second end, each securing rod port of the second plurality of securing rod ports configured to align with a corresponding securing rod port of the set of actuator securing rod ports and accept a securing rod of the predetermined set of securing rods therethrough.

5. The subsea dual set multi-piston smart flange of claim 4, wherein:
a) each securing rod of the predetermined set of securing rods comprises a threaded end configured to be accepted into a corresponding thread receiver in the first tubular; and
b) each securing edge comprises a threaded portion at either end of each tensioning rod configured to be accepted into a corresponding thread receiver in the first tubular.

6. The subsea dual set multi-piston smart flange of claim 1, wherein the first plurality of tensioning sleeve ports and the second plurality of tensioning sleeve ports are disposed alternatively equidistantly circumferentially.

7. A method of independent setting of seal providing simultaneous tensioning of all fasteners substantially simultaneously to provide efficient load distribution with minimum time for installation and contingency if required using a subsea dual set multi-piston smart flange comprising a predetermined set of tensioning rods, each tensioning rod comprising a securing edge and a tensioning edge; a predetermined set of tensioning sleeves corresponding in number to the predetermined set of tensioning rods, each tensioning sleeve of the predetermined set of tensioning sleeves configured to accept a tensioning rod of the predetermined set of tensioning rods therethrough, each tensioning sleeve comprising a pressure edge and a collar; a predetermined set of tensioners corresponding in number to the number of the predetermined set of tensioning rods, each tensioner of the predetermined set of tensioners configured to fit about a corresponding tensioning rod of the predetermined set of tensioning rods proximate the tensioning edge and secure that tensioning rod against the collar; a first tubular comprising an inner diameter defining a first inner channel, a first end, a first flanged face disposed at the first end, a first plurality of tensioning sleeve ports disposed circumferentially at and through the first end, each tensioning sleeve port configured to accept a tensioning sleeve of the predetermined set of tensioning sleeves therethrough, a seal receiver disposed within the first inner channel proximate the first end, and a seal actuator slidingly disposed at least partially within the seal receiver, the seal actuator comprising a predetermined set of tension rod ports corresponding in number to the first plurality of tensioning sleeve ports, each tension rod port of the set of tension rod ports sized to be smaller in diameter than an outer diameter of each tensioning sleeve of the predetermined set of tensioning sleeves and sized to accept a tensioning rod of the predetermined set of tensioning rods therethrough, each tensioning rod of the predetermined set of tensioning rods configured to secure into the first flanged face, each tensioning sleeve of the predetermined set of tensioning sleeves configured to selectively apply an adjustable load pressure to the seal actuator; a compressible seal disposed within the seal receiver where the seal actuator is slidingly engageable against the compressible seal; a second tubular comprising an inner diameter substantially the same inner diameter as the first tubular, the second tubular inner diameter defining a second inner channel, a second end, a second flanged face disposed at the second end and configured to abut the first flanged face, the second flanged face defining an actuator channel between an outer portion of the second flanged face and an interior of the second tubular, the seal actuator further slidingly disposed within the actuator channel proximate the first end, travel of the seal actuator towards the first tubular impeded by the first flanged face, and a second plurality of tensioning sleeve ports disposed circumferentially at and through the second end and corresponding in number to the number of the first plurality of tensioning sleeve ports, each tensioning sleeve port of the second plurality of tensioning sleeve ports comprising an inner diameter larger than an outer diameter of the collars, each tensioning sleeve port of the second plurality of tensioning sleeve ports configured to align with a tension rod port of the set of tension rod ports and accept a tensioning sleeve of the predetermined set of tensioning sleeves therethrough, the method comprising:
a) interfacing the subsea dual set multi-piston smart flange at an end of a tubular;
b) adjusting each tensioner of the predetermined set of tensioners to force each pressure edge against the seal actuator and, thereby, apply pressure to the compressible seal and compress the compressible seal; and
c) allowing travel of the seal actuator towards the tubular to be impeded by travel of the seal actuator towards the first flanged face.

8. The method of claim 7, wherein the subsea dual set multi-piston smart flange further comprises a limiter disposed intermediate the collars and the second flanged face, the method further comprising using the limiter to restrain the travel of the predetermined set of tensioning sleeves towards the first tubular.

9. The method of claim 7, wherein the subsea dual set multi-piston smart flange further comprises a tensioner configured to engage each tensioner of the predetermined set of tensioners, the method further comprising using the tensioner to adjust each tensioner of the predetermined set of tensioners to a predetermined tension to apply a predetermined pressure to the compressible seal.

10. The method of claim 9, wherein:
a) the tensioner is configured to engage each tensioner of the predetermined set of tensioners simultaneously; and
b) using the tensioner to adjust each tensioner of the predetermined set of tensioners to a predetermined tension to apply a predetermined pressure to the compressible seal occurs substantially simultaneously.

11. The method of claim 7, wherein each securing rod of the predetermined set of securing rods comprises a threaded end configured to be accepted into a corresponding thread receiver in the first tubular and each tensioning rod comprises a threaded portion at an end of its securing edge configured to be accepted into a corresponding thread receiver in the first tubular, the method further comprising:
a) advancing the threaded end of each securing rod of the predetermined set of securing rods into a corresponding thread receiver in the first tubular;
b) securing each securing rod of the predetermined set of securing rods into its corresponding thread receiver in the first tubular;
c) advancing each securing edge of each tensioning rod into its corresponding thread receiver in the first tubular; and
d) securing each securing edge of each tensioning rod into its corresponding thread receiver in the first tubular.

12. The method of claim 7, further comprising daisy chaining the tensioners to actuate the seal using all of the seal actuators.

13. The method of claim 7, wherein adjusting each tensioner of the predetermined set of tensioners to force each pressure edge against the seal actuator and, thereby, apply pressure to the compressible seal and compress the compressible seal comprises applying pressure to each collar to make the tensioning sleeve act like a piston.
